(19) United States
(12) Patent Application Publication
(10) Pub. No.: US 2005/0224033 A1
(43) Pub. Date: Oct. 13, 2005

(54) O-spring automotive spark plug grounding system

(76) Inventor: Thomas Ellen Linkenhoger, Tampa, FL (US)

Correspondence Address: THOMAS E. LINKENHOGER, 13516 WEST HILLSBOROUGH AVENUE, LOT 49A, TAMPA, FL, 33635, US

(21) Appl. No.: 10/915,843

(22) Filed: Aug. 11, 2004

Related U.S. Application Data
(60) Provisional application No. 60/560,766, filed on Apr. 8, 2004.

(51) Int. Cl. F02P 15/00

(52) U.S. Cl. 123/169 R

(57) ABSTRACT

The spark plugs on a automotive gasoline engine are and have always been dependent on the metal body of the engine for its path of least resistance for the flow of electricity from the spark plugs back to the vehicle battery. No doubt there is a disadvantage to this because this path is subjected to high heat which increases the resistance to the flow of electricity. In addition to the high heat there are mating surfaces of metal to metal which are internal within the engine and become corroded over time and they also offer a higher resistance to the flow of electricity. To solve this problem I have developed a spark plug connector which I call the O-Spring spark plug grounding connector which is attached to the external metal section of the spark plug and eliminates the need for the metal body of the engine as the path of least resistance to the flow of electrical current from the spark plugs to the vehicle battery. The combination of the spark plug connector and copper wire make a excellent ground return circuit for the spark plugs as described in the Detailed Description Of The Invention.

### CROSS REFERENCE TO RELATED APPLICATIONS

This application claims the benefit of PPA Ser. No. 60/560,766. Filed: Apr. 8, 2004 by the sole inventor.

### STATEMENT REGARDING FEDERALY SPONSORNED RESEARCH

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Automotive engine sparkplugs are a electrical device that have always been dependent on the body of the engine they were fitted onto for a electrical path back to the battery because the engine block and heads are made of metal which is considered to be a good conductor of electricity. As long as the battery ground buss cable connections are kept clean at the battery post and engine this is the excepted standard of operation.

It is my belief that there is always room for improvement when dealing with electricity. Especially now that we are driving vehicles that have micro processor computers controlling the engine and transmission. Lets not forget the sensitive electrical gauges on the dashboard. All of which could be subject to disturbance from the electrical noise or spiking from the high voltage arching of the sparkplugs.

### SUMMARY

Apart from possibly disturbing the computers and gages of the vehicle there is also the performance of the sparkplugs themselves to consider. It is known that metal offers a higher resistance to electricity as it is heated up. This principal has to apply to automotive engines considering the heat that they and the sparkplugs are subjected to. To improve upon this situation I have developed a grounding connector that is easily attached to the sparkplug and will connect the metal grounding section of the sparkplug to the battery ground buss cable on the engine via copper wire. Each sparkplug is fitted with a connector with a copper wire connection going to the engine battery ground buss cable connection on the engine. Of course the connectors and copper wiring are external to the engine and therefore not subject to the heat the engine is. Also it is common knowledge that copper wire is a better conductor of electricity then cast iron, aluminum and bolt connections.

### DESCRIPTION OF THE RELATED ART

When working with electricity and designing equipment that is using electricity the object is to provide a path of least resistance to the flow of the electricity as much as is possible. This principle holds true regardless of the type of electrical equipment it is if one wants to assure the best performance of the equipment.

In my experience at working with gasoline engines I have learned that over a short period of time the various pieces of equipment using electricity such as the starter and spark plugs can have difficulty operating because of the resistance that is building up at the mating surfaces in the path of the flow of electricity from the vehicle battery to the component and back to the battery. No doubt this resistance is due to the corrosion that has built up at not only at the exposed battery cable connections but also at the unexposed mating surfaces within the engine itself that are part of the path of the flow of electricity. Also the high heat the path is subjected to will offer more resistance to the flow of electricity. In the effort to solve this problem I have developed the O-Spring Automotive Spark Plug Grounding System which is described on page 5 in the Detailed Description of the Invention.

### DESCRIPTION OF THE DRAWINGS

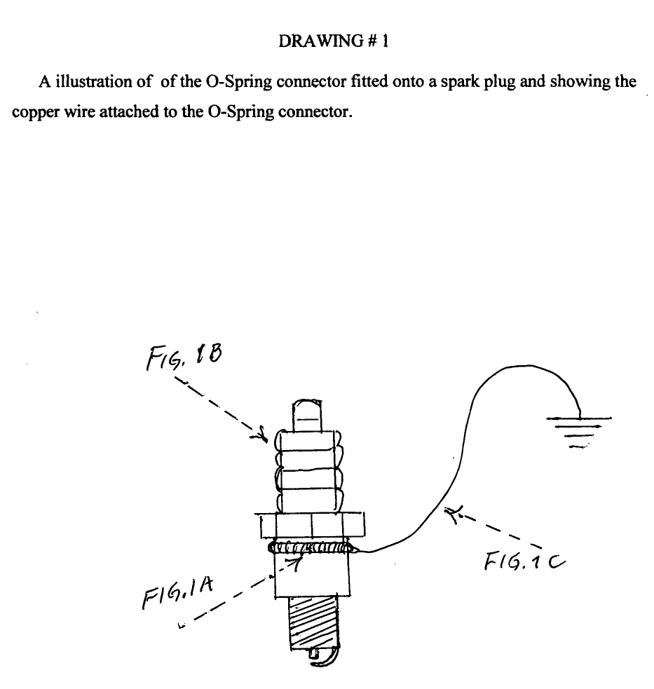

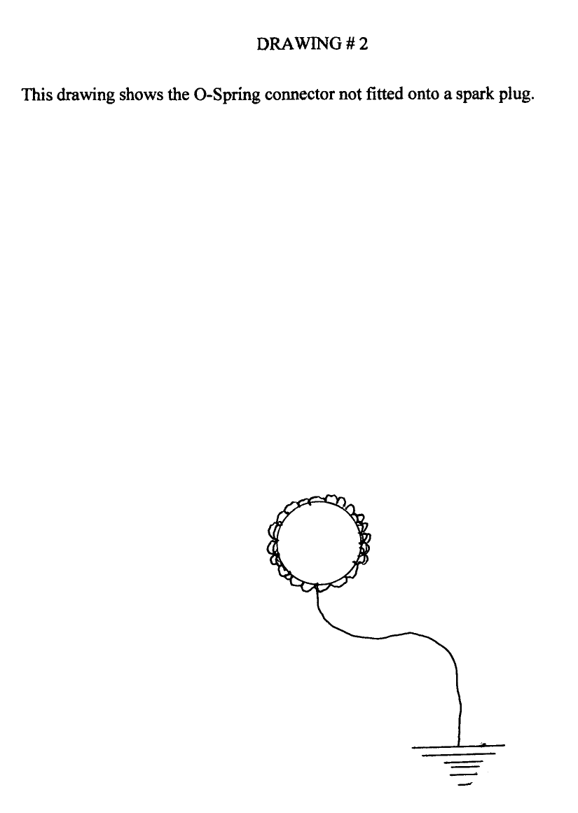

Drawing # 1—Page 8: Is a illustration of of the O-Spring connector fitted onto a spark plug. The connector has a copper wire attached to it which is part of the wiring harness which would go to the battery ground buss cable connection on the engine. FIG. 1A: Is the O-Spring fitted around the spark plug. FIG. 1B: is the spark plug. FIG. 1C is the copper wire.

Drawing # 2—Page 9: A drawing of the O-Spring connector before being fitted onto a spark plug.

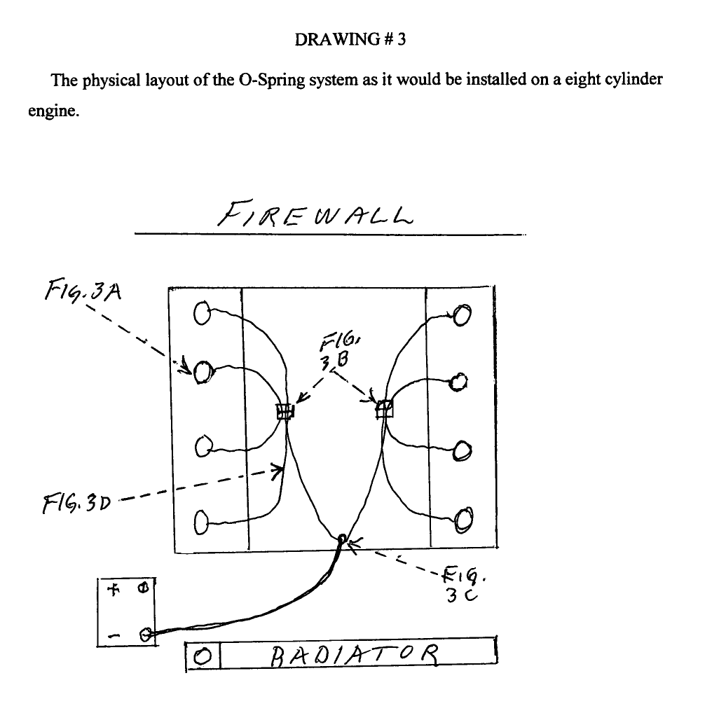

Drawing # 3—Page 10: Is a physical illustration of the O-Spring System as it would it would be installed on a eight cylinder engine. Installation on four and six cylinder engines would be similar. Parts list: FIG. 3A: (8) retention springs (Century Spring Corp. # 199-C). FIG. 3B: (2) “clip on” wire splicing connectors. FIG. 3C: (2) Ring terminals size 3/8 inch-16 gage. FIG. 3D (8) feet) 16 gage copper wire.

### DETAILED DISCRIPTION OF THE INVENTION

The present invention is intended to provide a excellent electrical path for the electrical current from the spark plugs of automotive gasoline engines back to the vehicle battery. It is known that copper wire would be a better conductor of electricity then the cast iron or aluminum the body of the engine is made of. It is also true that there there may be a build up of carbon deposits on the threads and seat of the spark plugs. This would present a resistance to the flow of electricity. Also when metal is heated up it will offer more resistance to the flow of electricity and this principal would certainly apply to gasoline engines.

To solve this problem I have developed a method of providing the spark plugs with a copper wire ground return path for the electrical current from the spark plugs back to the vehicle battery without having to go through the metal body of the engine which is subjected to high heat and thus will offer a higher resistance to the flow if electricity. Therefore the object of this invention is to provide the path of least resistance to the flow of electricity for the spark plugs.

The primary component of this invention is a new type of connector which I call the O-Spring Spark Plug Grounding Connector that clamps around the external metal section of the spark plug which is the point of grounding of the spark plug to the metal body of the engine. The spark plug connector is made by taking a small retention spring which is two inches long and one eight of a inch in diameter and forming a circle with it by turning the ends of spring toward each other and connecting them together. This procedure forms the circular shape of the O-Spring spark plug connector. After the O-Spring is formed the end of a copper wire is fitted into the ends of the O-Spring which are connected together. The copper wire is then soldered to the O-Spring at a 90 degree angle to the O-Spring as a permanent attachment. Then each of the individual copper wires are connected together at the battery ground buss cable connection on the engine. Thus becoming the assembly that makes up the invention.

1. I claim to have invented a means of providing the spark plugs of automotive gasoline engines a better path of least resistance to the flow of electricity from the spark plugs back to the battery ground (−).

2. The means of doing this according to claim 1 consist of a new type of metal connector designed specifically to clamp around the external metal section of the spark plug which is the grounding section of the spark plug to the metal body of the engine.
This connector is attached to a copper wire harness leading to the battery ground buss cable connection on the engine and is identified as the O-spring spark plug connector.

3. This new type of connector according to claim 2 consist of a metal retention spring that is two inches long and one eight of and inch in diameter formed into a circle by turning the ends of the spring toward each other and connecting the eyelets together thus forming the shape of the O-Spring connector.

4. The O-Spring connector according to claim 2 is combined with copper wire which is permanently attached to the O-Spring connector by a soldering procedure of lead acid solder with the copper wire connected at a 90 degree angle to the O-Spring connector.

5. Although the primary function of the O-Spring connector is to provide a path of least resistance to the flow of electricity. A secondary function of the O-Spring connector is to act as a cooling coil to radiate heat from the metal section of the spark plug. Thus offering less resistance to the flow of electricity. This is achieved because the coils of the O-Spring are not touching each other and therefore allowing air to flow through the coils and dissipating heat from the spark plug.

6. The O-Spring connector is self adjusting for the different sizes of spark plugs and will fit both 5/8 inch and ¾ inch spark plugs.
